(19) United States
(12) Patent Application Publication
(10) Pub. No.: US 2026/0204178 A1
(43) Pub. Date: Jul. 16, 2026

(54) System and method for hybrid guidance of an educational robot

(71) Applicant: ARISTOTLE UNIVERSITY OF THESSALONIKI - SPECIAL ACCOUNT FOR RESEARCH FUNDS, Thessaloniki (GR)

(72) Inventors: THEODOSIOS SAPOUNIDIS, THESSALONIKI (GR); PAVLOS MANTZIARIS, KARDITSA (GR); IOANNIS KEDROS, GREVENA (GR)

(21) Appl. No.: 19/136,862

(22) PCT Filed: Nov. 30, 2023
(86) PCT No.: PCT/IB2023/062073

§ 371 Date: Jun. 7, 2025

(30) Foreign Application Priority Data
Dec. 8, 2022 (GR) 20220101017

(51) Int. Cl. G09B 19/00; G06F 9/54

(52) U.S. Cl. CPC G09B 19/0053; G06F 9/542

(57) ABSTRACT

The invention relates to a system and method for hybrid programming an educational robot. The educational robot has the form of a game, which is easy to appeal to children from the age of three and older. It consists of a robot, a base and blocks with stored commands. The command blocks are connected to base. Parameter blocks are attached to the commands blocks, which parameterise the commands in the command blocks. The command blocks are connected to the base in sequence. The commands are transmitted from the blocks, via a common communication channel, to the base. The base, after collecting the commands, sends them, via a wireless network, to the robot for execution.

### TECHNICAL FIELD OF THE INVENTION

The present invention relates to a system and method for hybrid guidance of an educational robot, which is proposed to be in the form of a game that is easy and appealing to ages three and up.

Programming languages and the creation of algorithms usually use graphical user interfaces (GUIs), i.e. they require the use of a computer. The use of a programming language requires user training. This training is usually aimed at adults. The present invention introduces a simplified educational system based, at first, on the guidance of a robot by tangible means, so that it can be used by young children and introduce them to the world of algorithm creation and programming. This system is additionally combined with a graphical guidance environment and becomes a hybrid guidance system.

### STATE OF THE ART

A programming language is an artificial language that can be used to control a machine. The usual use of a programming language is to provide instructions to the machine for the machine to perform some tasks. Programming languages are framed by a set of syntactic and conceptual rules that define the structure and meaning of the language's sentences. Programming languages are used to facilitate the organization and management of information, but also for the precise formulation of algorithms. They are divided into computational and non-computational languages, such as HTML. Most programming languages have graphical user interfaces (GUIs), i.e. the user uses either graphical interfaces or characters in a text editor to create their program.

Programming languages are a type of software used in computer science to develop other software, in particular programs and applications, and to develop artificial intelligence.

Using a programming language is not simple. Usually, training is required, even for the simplest programming languages. Training may or may not consist of a course of seminars leading to a degree. Some programmers may be self-taught. In any case, the use of a programming language requires, in principle, a specific understanding of how it works, and such a knowledge is developed in people who are at least in their teens. At younger ages, how a programming language is used is usually not understood. However, it can be understood how the sending of instructions works. There are many computer games for children that are played with controllers, such as remote-controlled vehicles or game consoles connected to the television. These games are usually not educational, are aimed at children aged 10 and over, and the transmission of commands from the controller is relatively simple. Between the use of a programming language, which is graphical, and the simplified electronic game played with a controller, which lacks educational character and is aimed at older children, there is a stage at which even a young child can send commands to machines using tangible means of guidance.

Some toy manufacturers have produced toys containing tangible commands that are aimed at children under 10 years of age. Most of these games are played on a predetermined board, within which some predetermined commands are sent and executed. At best, the user chooses from a limited number of commands and executes each one individually.

European application EP3375503A1 concerns an educational toy consisting of tiles that are joined together to form a walkway on which a robot moves. The tiles are square and made of paper, with built-in commands, which also relate to motor properties. They are joined together to form either a straight line or an angle. The robot, by stepping on a paper tile, receives a motion command from it and moves only along the path it forms.

US application US20170007915A1 relates to an interactive robotic toy that also consists of tiles that are joined together to form a path, and also a robot that moves on this particular path. The difference in this toy is that the tiles are joined together by a system of interlocking knobs that snap into opposing recesses, while the shape of the tiles can be square or hexagonal. When the hexagonal tiles are joined together, they form corridors, which are not limited to straight lines and right angles but may also be diagonal. The robot also moves only on the corridor formed by the tiles.

International patent application WO2018229797A1 relates to an educational interactive toy that also consists of tiles that are joined together to form a path, and also a robot that moves on the path. The difference in this application is that the robot accepts commands from both the user and the tiles. The commands are only for movement on the path, e.g. go from tile A to tile C.

In addition to the above, some games do not allegedly incorporate a patent, and have a dashboard on which the command tiles are clipped. The robot usually moves on the same board by receiving the motor commands from the tiles via the board. Finally, there is a board game that, in one part, has holes with predetermined commands, in which the user places blocks with which the activates the command and sends it to the robot, which moves.

In all of the above cases, the robot either moves along the tile-formed path or uses a predefined dashboard to program itself. The robot executes mainly motor commands, while the commands are predefined and not controlled by the base because they are passive (no intelligence). In these systems, commands are usually transmitted by the dashboard itself, which sometimes acts as a control center. All of the above toys are aimed at children and their capabilities are limited, as they can only move or be programmed on a predefined surface, i.e. a treadmill or a dashboard. The most important and common feature of all the above systems is that they implement a tangible system with predefined commands. None of them simultaneously applies graphical programming and, more importantly, does not combine tangible and graphical programming subsystems where the two subsystems can communicate between them. Therefore, of the systems known to date, none has active commands (with intelligence) controlled by the base with a common communication channel, none has parameters with sides (up-down faces) representing different programming concepts, none has commands that set and read the parameters, none can be programmed remotely, none has the possibility of upgrading software via the Internet to the base and the robot, none is hybrid, i.e. combining both tangible and graphical programming at the same time, and none can program the robot and the base remotely. The present invention solves the above problems by applying, for the first time, the combination of innovative technical features.

### SUMMARY OF THE INVENTION

The main innovative characteristics of the invention are the following.

The invention concerns an educational robot guidance system consisting of a) a robot (23), b) a base (1), c) blocks of stored commands (13), d) a communication bus (9), and e) parameter blocks (21), characterized in that each one of the blocks has a direct connection to the communication bus so that each instruction block communicates directly with the base.

The robot has a display (23) with a frame of magnets (6).

The robot (23) has an aluminum apron (25).

The robot (23) has a command that downloads an image from the internet and displays it on the robot's screen.

The robot (23) has a command that downloads from the internet and plays an audio file.

The robot (23) has WebSocket allowing a remote web server, to have two-way communication with the robot to send and receive commands in real-time.

The robot (23) has a tangible command that activates Internet of Things (IoT) devices or to activate events and/or programs by sending and receiving data from web services (POST and/or GET requests).

Each parameter block (21) can be connected both inverted (top-bottom) and thus incorporate simultaneously more programming concepts (e.g. number parameter on the top side and sensor parameter on the bottom side).

The guidance is done tangibly as follows (a) blocks with stored commands (13) are connected to the base (1), with connection achieved by the magnets and the recesses
projections mechanism; (b) the wiring of the power supply, the command transmission, the grounding and the common communication bus are aligned, through which the stored commands are returned from the blocks to the base, c) parameters are connected to the command blocks (21), d) the execute button (2) is pressed, e) the base (1) sends a read request to the command blocks (13) in sequence, f) the request is transmitted from the block closest to the base (1) to the furthest block, through the aligned wiring, g) each command block (13), taking into account any parameter block (21) connected, sends the command stored, which may or may not be parameterized, to the common communication bus (108), through which all commands from the blocks are transmitted to the base (1) and the base (1) sends one by one the commands to the robot (23) for execution, h) the robot (23) executes the commands, i) each time the robot (23) executes a command a light is switched on in the corresponding command block (13) whose command is being executed.

The programming can be done hybridly, with the combination of tangible and graphical programming, using command blocks (13) operating system in a graphical environment (35) for the sending or changing the commands stored in the blocks, which transmit the commands to the base (1), which, after collecting and checking the commands, sends them to the robot (23) for execution.

The robot (23) and the base (1) each have an access point and a web page through which they are configured.

The robot (23) to the base (1) is made by assigning a name and a code to the base (1), via its access point, and assigning the same name and code to the robot (23), via its own access point.

The base (1) is capable of saving in a command block (13), which is connected to the side where the “save” port is present, a series of commands stored in one or more commands blocks (13) which are connected to the “execution” port of the base (1), to which the common communication bus (108) between the base (1) and the command blocks (13) terminates.

The direction of the data can vary depending on the correct output.

The communication of several blocks with a base (1) is performed in a bidirectional serial manner, wherein the width of the information going back and forth is variable in both directions.

### DISCLOSURE OF THE INVENTION

The present invention consists of a hybrid guidance system for an educational robot comprising circuitry and software. The machines are a) a robot, b) a base, c) blocks with stored instructions, d) a common communication bus (9) of the base with the instruction blocks, e) parameter blocks, and f) a display with an operating system.

The basic guidance system includes a) a robot, b) a base, and c) command blocks with stored commands, connected to the base. The command blocks are connected to the base in sequence, the commands are transmitted from the blocks and sent over a common communication channel to the base, which, after collecting and checking the commands, sends them, via a wireless network, to the robot for execution. This system is a tangible guidance system, as it relies on physical objects. The user picks up the blocks and connects them to the base, creating a sequence of commands. In this basic tangible system, parameter blocks can also be attached to the basic tangible system, which are connected to the instruction blocks and parameterize the instructions stored in them. In addition, the instructions stored in the instruction blocks can be altered under graphical guidance, i.e. utilizing an operating system that communicates wirelessly, via the base, with the instruction blocks.

The base, which has, for example, a rectangular shape, is the control center, where the commands from the command and parameter blocks are collected and transmitted to the robot for execution. The base has two buttons, one of which is used to save in command blocks the sequence, which is connected to the base, and the other to transmit the commands directly to the robot. The command blocks, which are, indicatively, square in shape and, being smaller than the base, each have an embedded command or a stored sequence of commands. The instruction blocks are joined to the base and to each other by magnets, forming a series of instructions. Each instruction block can accept up to one parameter. The parameter, which may involve, for example, repeating the instruction twice, is given to the instruction block via a parameter block, which, typically, is rectangular shaped. The parameter block is also connected, by a magnet, to the instruction block.

The base circuit and the instruction block circuits have connectors with four identical pins that are connected when the base is connected to the blocks, of which the first pin is used to supply power from the base to the blocks, the second pin is used to transmit instructions from the base to the blocks, the third pin is used to allow the blocks to return the instructions they have stored, and the fourth pin is used for grounding. The pins in connectors may be more or less, but there are at least three.

Also, the base, the command blocks, and the parameter blocks have magnets to connect them together. The base has north-polarity magnets. Each instruction block on one side has south-polarity magnets so that it can be connected to the base, and on the other side has north-polarity magnets so that it can be connected to the side that has south-polarity magnets of another instruction block. Each instruction block has magnets on a third side, to which a block with a parameter can be connected.

In addition to magnets, a physical barrier system, based on recesses and projections, is applied to the connectivity. The base on the sides connected to the command blocks has at least one physical barrier to achieve the correct connection of the wiring, which consists of a projection and a recess. Furthermore, each command block on the sides connected to another block and to the base has a physical barrier, to achieve correct connection of the wiring, consisting of at least one projection and at least one recess. The mechanism shall operate as follows. On the side of the base, where a command block is to be connected, there is a recess and a projection. On the instruction block, there is also a recess and a projection, but oppositely, that is, opposite the recess of the base there is the projection of the block, while opposite the projection of the base, there is the recess of the block. This mechanism ensures that the wiring of the base and the blocks will be connected correctly, without the risk of the circuit being damaged. Thus, if the user tries to apply the base upside down with one block or two blocks together without each lug snapping into a recess, then a connection is not achieved. This mechanism also contains an educational function, since the user realizes that the is not applying the individual parts of the system correctly and that he has to reverse the block to snap it, thus learning from his mistakes.

The user tangibly joins the blocks of commands to the base, and by pressing the button of transmission of the commands, the commands are sent to the robot, which executes them in the order in which they were given to the base, i.e. in the order in which the blocks of commands were joined to the base. The user can vary the combination of commands and parameters as desired.

This system can be connected to a monitor with an operating system, such as a computer, tablet, or mobile phone. The system has software that digitally represents the base and command blocks. The user can digitally connect the command blocks to the base and send the commands to the robot via a computer, tablet, or mobile phone. Also, through the software, he can change the commands that each command block has. In other words, it is a system that is dynamic, changeable, and interactive, but, above all, it is a hybrid system, as it combines the guidance of the robot with tangible and graphic means.

### The Robot

The robot has wheels, a torso, a motor (or motors), a screen, lights, and speakers, and can move on almost any fixed surface. The movement of the robot is not limited to a predetermined path, dashboard, or other predetermined surface. There are indicatively two wheels, one on each side, but there may be more. The torso has an indicative height of 5 cm but may have a greater or lesser height. Also, the robot has a display on the top of the torso, on which faces with various features and different expressions are displayed. The frame around the screen may be made of magnetized metal to apply various metallic things and accessories, such as hair, hats, etc. Below the screen, there is an aluminum apron on which the user can write, draw, and erase. The robot also has speakers, from which sounds, voices and music can be emitted, as well as lights that can change colors and flash. Furthermore, the robot may have a capacitive touch sensor, a temperature gauge, a sensor for measuring light, distance, and gesture recognition, a color sensor, as well as a microphone amplifier for audio recognition and an SD card for reading and writing files.

The robot is powered by any known means, existing or future. Indicatively, it can be done as follows. It can be powered by an 18650 Lithium-Ion battery. The TP4056 integrated circuit is used for charging it, and for its protection, the DW01 battery management system in combination with the mosfet FS8205A package is used. The battery voltage in its first stage is increased by the booster, to 5vDC, and then reduced to 3.3vDC. This is done to have a constant supply at 3.3vDC over the entire battery operating range (4.2vDC-3.7vDC). The robot battery has overcharge, overcharge, and overcurrent protections.

The robot has a USB port, which functions both as a charging port and as a connection port to a device from which it receives commands, such as a computer, tablet, smartphone, or any other device through which one can graphically control the robot.

The robot and the base communicate bidirectionally, as the base has a bidirectional communication algorithm with the robot. The robot and the base have an access point, a web server, which hosts one or more websites through which they are configured. The robot is connected to the base by assigning a name and a code to the base via its access point and entering the same name and code to the robot via its access point. In addition, the robot consists of four autonomous output circuits: a) motor controller to control the two motors, b) display connector to connect the robot's display, c) audio amplifier to drive the robot's speaker, and d) Led RGB. At the heart of the robot is a microcontroller, indicatively, a dual-core ESP-32 type, which is responsible for the entire operation of the robot.

The microcontroller also manages the internet connection, the connections to the bases, the SD card for storing files, the robot's outputs and inputs, and monitors the battery level.

The SD and the Monitor are connected to the robot via the SPI interface of the microcontroller. The output of the speaker is controlled via the I² S interface. The control of the motors is done through PWM signals that drive the H-Bridge. The RGB LED is controlled via the WS2812 library. The Light, Color, Distance, and Gesture Sensor (APDS Sensor) is connected via the I² C interface and is only activated when its inputs need to be read. The Temperature Sensor shall be read via an analog voltage amplifier. The touch sensor is controlled by the microcontroller itself, via the touch interface. The microphone is read via an analog voltage amplifier.

The robot has an indicative 520 KB of RAM and 4 MB of internal memory divided as follows:

TABLE P.1

| ID | Name | Size |
|---|---|---|
| 1 | bootloader | 0x7000 |
| 2 | partition table | 0xC00 |
| 3 | NVS | 0x5000 |
| 4 | Take data | 0x2000 |
| 5 | Factory | 0x80000 |
| 6 | Main App | 0x200000 |
| 7 | Images | 0x100000 |
| 8 | Settings | 0x20000 |

Bootloader: it is responsible for proper booting.
Partition Table: contains the structure of the flash.
NVS: Contains system settings.
otta_data: It is responsible for which will be the next partition to be executed.
Factory: is responsible for upgrading their software system
Main App: the main program of the robot
Images: contains the images and icons used by the main program.
Settings: save user settings.

The robot can move on the wheels forward, and backward, turn left or right. On the screen, faces are displayed which can change features and expressions, as well as words, expressions, and sentences. The robot can also emit sounds, voices, and/or music, flash the lights on it in different colors, and send commands to other devices and/or mechanisms, for example, to switch a light on or off or to activate a radio. In terms of voices, there is the possibility, with graphical guidance, for the user to write text and the robot to reproduce the text by voice reading.

The local user, to connect to the robot, can either connect directly to the robot's Access Point or connect to the local router to which the robot is connected. In this way, the local user can access, via a web browser, the web pages hosted locally on the robot's server. The web pages hosted on the robot are: a) robot configuration web pages with which users can configure the robot's functions, including but not limited to: its speed, the images and profiles it will use, the volume of sounds and tones played by the robot, the details of the local router to which the robot will be connected, the sensitivity of the sensors, etc. (b) a web page which allows the local user to change the commands stored in the command blocks. (c) a web page for sending commands, which allows the local user to send, via a graphical interface, guidance commands to the robot or even to send, via the robot, commands to be stored in multi-command blocks which are connected to the base.

The local router allows the robot to connect to the internet, and therefore to a remote internet server. This connection is made via WebSocket, after the robot has been activated, and an identification key has been generated by the web server. Each robot can be claimed by only one user to whom it belongs. WebSocket allowing a remote web server, to have two-way communication with the robot to send and receive commands in real-time. In this way, the robot is guided by a GUI, which is hosted on the remote web server as long as the remote user has access to that web server. At the same time, the robot can send and receive settings, and files, as well as send logs, to generate usage statistics.

For the robot to utilize the WebSocket features, the user must have a remote control enabled on their robot and an active internet connection. The connection process exactly follows the WebSocket protocol connection procedure, i.e. initialization and communication channel binding, and the remote server checking the authentication key sent with the handshake packet decides to accept or reject the connection. If the connection is accepted, the channel remains open for two-way data exchange between the remote server and the robot.

The internet connection allows the robot to control Internet of Things (IoT) devices or to activate events and/or programs by sending and receiving data from web services (POST and/or GET requests). The web service in turn handles the robot's requests in order to produce the actions desired by the user. Indicatively, such web services could be software platforms that connect devices and services, from different users to activate one or more automation related to these applications, devices, and services.

The robot can accept asynchronous or synchronous commands. Asynchronous commands are commands that are not deactivated by themselves, i.e. there is another command that deactivates them. Synchronous commands are commands with a specific execution time, after which they are deactivated.

The basic commands are as follows a) “STEP”, b) “MOTOR_ADV”, c) “DISPLAY_PRESET”, d) “DISPLAY_FACE”, e) “PRINT_TEXT”, f) “AUDIO_MP3”, g) “AUDIO_RADIO”, h) ‘AUDIO_T2S’, (i) ‘RGB’, (j) ‘IOT’, and (k) ‘DELAY’. All commands can be sent to the robot, and executed, either from a base (from single command or multi-command blocks), or via the page hosted on the robot, or remotely from (websocket).

The “STEP” command moves the robot in predefined steps, with a configurable number of repetitions. It is divided into four sub-commands:
Front-Identifier: 64 (0x40)·
Rear ID: 65 (0x41)·
Left-Identifier: 66 (0x42)·
Right-Identifier: 67 (0x43)

The command takes a byte parameter, with bounds: of 1-9 inclusive, indicating the number of steps (iterations).

The command is affected by four settings: i) the ‘stepSize’ setting, which determines the time of the step, ii) the ‘stepSpeed’ setting, which determines the duty cycle of the PWM signal of the motors, iii) the ‘motorOffset’ setting, which determines the divergence of the right motor with the left motor and iv) the ‘turnSize’ setting, which determines the time of the turn.

The command has a variable runtime, depending on the settings and the number of steps. The command is synchronous.

The command “MOTOR_ADV”, controls the motors of the robot and consists of one command:
Motor ADV-Identifier: (0x40)

### The Command Takes 3 Parameters:

Direction (front, back)
Engine (right or left or both)
Speed (0-255)

The command is affected by the MotorOffset setting (Determines the offset of the right to left motor)

The command has a fixed runtime. The command is asynchronous.

The command “DISPLAY_PRESET”, displays one of the system's, or user's if configured, images on the screen. The command is divided into:
Simple-Identifier: (0x47)
Advanced (adv)-Identifier: (0xA1)

### The Command Takes 2 Parameters:

The number of the image (1-9 inclusive).
The time the image will remain on the screen (in milliseconds)

The command has a variable runtime, depending on the time parameter, plus about 500 ms to execute. The time parameter is optional, and its default value is set by the ‘ImageTime’ setting. The command is synchronous. The simple command ignores the time parameter, while the advanced command needs it.

The command “PRINT_TEXT” writes text to the screen. The robot can only print Latin characters, any other character will be displayed as ‘?’. The command is divided into:
Simple-Identifier: (0xA2)
Advanced (adv)-Identifier: (0xA4)

### The Command Takes 7 Parameters:

The text
The size of the font (1-4 inclusive)·
The original ‘X’
The original ‘Y’. The time it will remain on the screen
The color of the font.
The color of the background

The instruction has a variable runtime, defined by the time variable (in ms), plus about 200 ms to execute it. The time parameter is optional and its default value is set by the ‘PrintTime’ setting. The command is synchronous.

The simple command ignores the time parameter, while the advanced command needs it.

The command “AUDIO_MP3”, plays the system or user sounds on the speaker if configured. The command is divided into one category:
Audio-Identifier: (0x48)

### The Command Takes One Parameter:

The sound ID (1-9 inclusive)

The command has a variable runtime, defined by the size of the audio file, plus about 200 ms to execute it. The command is synchronous, however, there is an option for asynchronous, but only for the system. The command is affected by the ‘audioVolume’ setting.

The command “AUDIO_RADIO”, connects and plays an internet radio station of the user's choice. The command is divided into two sub-commands:
Radio Start-Identifier: (0x49)
Radio Stop-Identifier: (0x50)

### The Command Takes 2 Parameters:

Station ID (1-9 inclusive)
Top (true or false)

The ‘Start’ parameter is set by the command. In the case of a ‘Radio Start’ command the ‘Start’ parameter is set to ‘true’, while in the case of a ‘Radio Stop’ command, the parameter is set to ‘false’.

The command has a fixed execution time since it is asynchronous. The command is affected by the ‘audioVolume’ setting. In case the ‘Radio Start’ command is in operation, and an ‘AUDIO_MP3’ command is executed then the ‘Radio Start’ command is automatically stopped.

The command “AUDIO_T2S”, takes as a parameter text, which it converts, via the remote web server, to mp3 sound which it plays. The command consists of one sub-command:
T2S-Identifier: (0xA5)

### The Command Accepts 1 Parameter:

The text to be converted

The Command has a variable runtime, determined by the text to be converted. The command is affected by the ‘audioVolume’ setting and by the ‘t2sLang’ setting. The command requires internet access. In case the ‘Radio Start’ command is in operation, and an ‘AUDIO_T2S’ command is executed, then the ‘Radio Start’ command is automatically stopped.

The “RGB” command controls the color of the LED on the robot. The command is divided into three sub-commands:
Simple-Identifier (0x44)
Erase-Reader (0x45)
Advanced (adv)-Identifier (0xA6)

The command is asynchronous. The command in its simple form takes a number parameter corresponding to predefined colors.

### The Command Takes 3 Parameters:

Red-Amount of red light
Green-Amount of green light
Blue-Amount of blue light

The erase command does not accept parameters. The command in its advanced form accepts 3 parameters corresponding to the amount of red, green, and blue light. The command has a fixed execution time. The command is asynchronous.

The “IOT” command needs an active internet connection to run and makes a request to the URL specified by the user. The command consists of a sub-command:
“IOT”—Identifier: (0xA7)

### The Command Takes 2 Parameters:

The address identifier (URL) (1-9 inclusive),
And a binary boolean, specifying whether the request will be POST (true), or GET (false)

The command is synchronous and has a variable execution time proportional to the duration of the request response. The maximum waiting time is 60 seconds.

The command “DELAY”, runs a time delay on the robot. The command consists of one sub-command:
Delay-Identifier: (0x56)

The command takes 1 parameter.
The time of the time delay in ms

The instruction has a variable runtime specified by the time delay variable plus 200 ms.

The command “NET_IMAGE” downloads an image from the internet and displays it on the robot's screen. The command requires an active internet connection to run and an authenticated connection to the remote web server.

The command consists of one sub-command:
“NET_IMAGE” identifier (0xC0)

### The Command Takes 3 Parameters:

The image ID (0-32767 inclusive),
And a boolean operator, which defines whether or not the image will be taken from the user's personal images.
The time it will remain on the screen

The command has a variable runtime, determined by the time to retrieve the image plus the time to keep it on the screen plus about 500 ms to execute it.

The command is affected by the “imageTime” setting. The command is synchronous. In case there is no image with this identifier, a default image is downloaded.

The command “NET_SOUND” downloads from the internet and plays an audio file. The command requires an active internet connection to run and an authenticated connection to the remote web server.

### The Command Consists of One Sub-Command:

“NET_SOUND”-identifier (0xC1)

### The Command Takes 2 Parameters:

The audio ID (0-32767 inclusive),
And a boolean operator, which specifies whether or not the sound will be taken from the user's personal sounds.
   The command has a variable runtime, defined by the size of the audio file, plus about 200 ms to execute it. The command is synchronous, however, there is an option for asynchronous, but only for the system. The command is affected by the ‘audioVolume’ setting. In case there is no sound with this identifier a default sound is downloaded.

Connecting the robot to the internet allows the robot to connect to a remote web server to upgrade software for the robot and the base.

The software update process includes (a) the robot software update, (b) the update of the base software file, which is stored in the robot's memory and is used exclusively to service the base software update process, and (c) the robot resource files. The resource files include the icons and expressions displayed on the robot's screen, the basic sounds and images, and the files required to service the robot's local server.

The process of updating the robot's software starts when the user, through the GUI, hosted on the robot's local server, presses the software upgrade button.

The robot sends its software version number via HTTP request to the remote server, which checks from its database if the software version is the latest one. If it is, it replies to the robot that it has the latest version and the robot informs the user.

If there is a newer version of the software, the robot downloads, and stores the update file in its memory. If and when, the download of the new version software file is completed, the robot starts the ‘Factory App’.

The software responsible for the system update process unpacks the new software version file, deletes the old files from the robot's memory, and then writes the unpacked files to its memory.

If, there is a screen resource update file then, the update software, deletes the ‘Images’ memory area and after copying the image file to this area, it deletes the file it copied.

At this point, the software update process is finished, and the robot starts the main software located in the ‘Main App’ memory area.

### The Base

The base is the control center of the tangible system. It is where the commands are connected and configured by the user. From the base, the commands are transmitted to the robot, which executes them in the order in which the user has connected the corresponding command blocks to the base. The base consists of (a) charging, power supply, (b) USB circuit, (c) communication ports, (d) control buttons, and (e) firmware.)

The base is fed by any known means, existing or future. Indicatively, it can be done as follows. It may be powered by an 18650 Lithium Ion battery. The TP4056 integrated circuit TP4056 is used for charging, and the DW01 battery management system in combination with the Mosfet FS8205A package is used for protection. The battery voltage in its first stage is increased by the booster, to 5vDC, and then reduced to 3.3vDC. This is done to have a constant supply at 3.3vDC over the entire battery operating range (4.2vDC-3.7vDC). The base battery has overcharge, over-discharge, and overcurrent protections.

The USB port, indicated Type-C, is responsible for powering the charging circuit, as well as receiving commands from the base.

The base has two communication ports: a) the “save” port for storing a program or changing a command block instruction, and b) the “execute” port for connecting command blocks to be executed on the robot. These 2 ports contain internal pull-down resistors which help to reject data errors when connecting instruction blocks to the base.

The base has two control buttons. The “save” button starts the process of saving programs from the “execute” port to the “save” port. The “execute” button starts the program execution process.

The base has a buzzer for audible feedback to the user, using sounds of varying duration and frequency.

At the heart of the system is a microcontroller, indicatively a dual-core ESP-32 type, which is responsible for the entire operation of the system.

As for the “save” button, the base can store in a command block, which is connected to the “save” side of the “save” port, a series of commands stored in more than one command block and connected to the base's “execute” port, where the common communication channel between the base and the command blocks ends.

The firmware, i.e. the permanent software that is programmed to run and resides in flash memory, is written in the C++ programming language and consists of 2 parts. The main program, which runs continuously, and the Factory-App, which is responsible for updating the main program from memory.

The base has an indicative 520 KB RAM and 4 MB internal memory which is divided as follows:

TABLE B.1

| ID | Name | Size |
|---|---|---|
| 1 | bootloader | 0x7000 |
| 2 | partition table | 0xC00 |
| 3 | NVS | 0x5000 |
| 4 | Take data | 0x2000 |
| 5 | factory app | 0xA0000 |
| 6 | Main App | 0x100000 |
| 7 | Update | 0x100000 |
| 8 | Backup | 0x100000 |
| 9 | Settings | 0x50000 |

The execution of the user's program starts when the “execute” button is pressed, with which the base starts the program reading process.

The base microcontroller prepares a packet in which the command byte has the value “0x50”, representing the value of the “read identities” command, and the parameter (“parameter1 byte”) has the value “0x00” (Zero). The other variables in the packet are not used. It then sends the packet to the “execution” port and waits for the command block response packet on the ‘COMMON BUS’ for up to two seconds.

If it gets a response, it stores the response in its memory and increments the value of the packet's parameter (“parameter1 byte”) by 1. It resends the entire new packet to the “execute” port and waits for a new response from the next connected instruction block. Therefore, the value of the parameter, plus one, corresponds to the location of the physical instruction block of the sequence bound to the base.

When it gets no response, the base considers that it has reached the end of the user's program.

After the reading process is finished, the program execution process starts.

The base reads the command from its memory with the command in which it is located as a pointer. It then decodes the command and appropriately sends the command to the robot. At the same time, it sends the “turn on Led” command using as a pointer the command block from which the command originated so that this command block turns on its LEDs.

It then waits for the robot's response. When it gets a response it sends the “turn off led” command using as a pointer the command block from which the command originated, so that the specific command block is turned off.

It then checks if there is a next instruction in its memory, and if there is, it repeats the same process.

If not, the commands have been executed and the program execution process is terminated.

If the “Syntax Error Check” setting is enabled, then before the program execution process starts, the base runs the error-checking process.

When starting the error-checking process, the base searches for possible errors. These errors may be, a) syntactic or b) parameterization errors.

Syntax errors can be: a) initialization of the command “IF” without the appropriate command “IF_END” b) initialization of the command “FOR” without the appropriate command “FOR_END” c) orphaned command “IF_END” without a primary command “IF” d) orphaned command “FOR_END” without a primary command “FOR_END”.

Parameterization errors occur when the user associates the wrong parameter blocks with commands of a) the wrong type or b) command blocks that do not receive parameter blocks.

If an error is read, the base cancels the program execution process and then sends the “LED Animation” command to the command blocks in which it detected errors to virtually inform the user.

The instruction storage process only applies to specific blocks that allow instruction storage.

Storage can be done in two ways a) from the GUI and b) from the base. The process of saving commands from the base starts when the user presses the “save” button.

At first, the base sends the “read command” command to the command blocks and stores the commands it has received in a table.

The base checks the number of bytes it will try to store in the multi-instruction block, if it exceeds 250, then it rejects the storage.

It then checks, sending the “alive” command to the command block located in the ‘save’ port. If there is a command block, then it responds with an acknowledgment (ACKNOWLEDGE)”, and the base knows that there is a command block.

The base reads the ‘Settings Byte’ of the command block in the ‘save’ port.

And checks if the command block is multi-command, and is available for writing. If it is not, the save is rejected.

Then one by one the base sends the bytes of the commands with the “WRITE EEPROM” command. For each byte there is a timeout of 1 second, and up to 3 attempts. This is in case the user removes the command block, or the EEPROM has reached the maximum write cycle.

After, and if, all bytes are written, then the base sends the “WRITE_LENGTH” command to also write the number of bytes in the command block.

The process at this point is complete.

The process of saving commands from the GUI begins when the user presses the GUI's “Save” button.

At first, the GUI, through Blockly, collects the commands of the program created by the user. Then, it asks the user to select the base to which the multi-command block is connected.

After selecting the correct base, from the list of connected bases, press the “DONE” button on the GUI.

The robot sends the program to the base for storage, and the base in turn starts the program storage process.

At first, the base stores the commands it has received in a table.

The base checks the number of bytes it will try to store in the multi-instruction block, if it exceeds 250, then it rejects the storage.

It then checks, sending the “alive” command to the command block located in the ‘save’ port. If there is a command block then it responds with an acknowledgment (ACKNOWLEDGE), and the base knows that there is a command block.

The base reads the Settings Byte of the block in the ‘save’ port, and checks if the block is a multi-instruction block, and is available for writing. If it is not, storage is rejected.

Then one by one the base sends the bytes of the commands with the “WRITE EEPROM” command, with the memory location as a pointer. The base waits up to 1 second for a response from the multi-instruction block. If it does not receive it, a timeout occurs. The attempt is repeated up to three times. This is done in case the user removes the command block, or the EEPROM has reached the maximum write cycle.

After, and if, all bytes are written, then the base sends the “WRITE_LENGTH” command, with the number of commands as the value. Thus the multi-instruction block has recorded both the instructions and their number.

The process at this point is complete and the base responds to the robot.

In turn, the robot displays a message in the GUI, depending on whether the storage was successful or not.

The process of changing a command in a command block only applies to variable command blocks, which allow changing the command stored in command blocks.

The process of changing the instruction of variable instruction blocks starts by attaching a block to the base, ‘save’ port. The successful connection of the block is indicated by the animation of the block's LEDS.

The user then logs in to the robot, to which the base that has the variable command block attached, opens the web page hosted on the robot's local server (or application) and navigates to the stored command change page.

He then selects the command he wants to apply to the variable command block, and proceeds by following the instructions on the screen.

After selecting the desired base from the list of connected bases, press the “DONE” button.

The robot sends the command, selected by the user, to the base and the base in turn starts the process of changing the stored command in the connected block.

When the process is completed, the base responds to the robot and the robot sends a success or failure message to the user's screen.

The Steps are, in Detail, as Follows:
The application sends an HTTP request to the robot's server, the endpoint responsible for the process. Giving the ‘LocalIP’ of the selected base, and the selected command as ‘query’ parameters. The robot waits for a response to the request.
The robot sends a request to ‘LocalIP’ on the Endpoint responsible for the process, giving the selected command as a query parameter.
The base receiving the request sends the “read command” command to the ‘save’ port to check if there is a connected block.
If there is no block it returns an error.
The base sends a read command of the ‘Setting Byte’, and checks if the block is a variable command block.
If it is not, it returns an error.
It then sends an EEPROM storage command, with address ‘0’ and value the command.
If it is not successful the action returns incorrectly.
If it is successful, it returns with a success message.
The robot gets the answer and returns the same message to the request.
The Dashboard gets the response and displays the message on the user's screen.

The base has three local settings which are stored and configured by using the web page or web pages of the webserver running on the base.
Name—The name of the robot that will try to connect.
Password—The password with which the robot will try to connect to the robot
Friendly Name—Identifying names to allow the user to distinguish multiple bases connected to a robot.

The base when connecting to the robot takes settings that are stored in the robot, and are configurable by the user through the robot's server web page(s). These settings are lost from the base after each reboot and are reapplied upon successful robot connection.
‘Buzzer Enabled’—Enables the base buzzer
‘Delay Between Commands’—The time delay between commands during program execution.

The firmware update process is automatically initiated when the base is connected to a robot if the software version of the base does not match the version required by the robot.

At first, the base downloads the software file from the robot and stores it in the ‘Update’ memory area. It then starts the software located in the ‘Factory App’ memory area, copies from the ‘Update’ memory area to the ‘Main App’ memory area, erases the contents of the ‘Update’ memory area and starts the software located in the ‘Main App’ memory area.

In case of incorrect firmware, the base starts the application located in the ‘Factory App’ memory area. It then copies the application located in the ‘Backup’ memory area to the ‘Main App’ memory area and starts the software located in the ‘Main App’ memory area. The ‘Backup’ memory area contains the latest stable version of the base software from the manufacturer.

### The Command Blocks Version 1^{η}

Instruction blocks of all types contain a microcontroller that is responsible for all the operations that the block performs.

The block is connected from left to right. So each block on its left side can be connected either to a base or to another block. On its right side, however, whenever there is a connection, it is always connected to another block.

Each block has a parameter port at the bottom, to which only parameter blocks can be connected.

The block is powered from the left port and downgraded to 3.3vDC.

The block circuit consists of the following parts:
The main microcontroller (indicatively ATmega328)
The voltage stabilizer
The connecting ports.
The information LEDs
The data output selection gateway

The block firmware is written in the C++ programming language.

Each command block needs 2 serial ports, of which the second port needs only the send pin.

In particular, the block reads from the ‘ATMEL_RX’ pin of the circuit, from the previous block. It writes data to the next block through the ‘NEXT_CUBE’ pin. Sends data to the base, through a three-state gate, from the ‘ATMEL_TX’ pin. The output of the gateway is the one that gives the data to the ‘COMMON BUS’ through the ‘GATE_OUT’ pin. Control of the gate is done through the ‘GATE_CTNL’ pin.

The configuration of the command blocks is done by a byte stored in the EEPROM memory at position 0xFF.

The communication between the blocks and between the blocks and the base is done serially in the form of packets. There are two different types of packets a) packets from the base to the blocks and from the blocks to another block and b) outgoing packets from the blocks to the base.

### Specifically:

a) for communication between the blocks and between the blocks and the base, the packets consist of six bytes and have the following format:
   1. ‘header byte’
   2. ‘command byte’
   3. ‘parameter1 byte’
   4. ‘parameter2 byte’
   5. ‘parameter3 byte’
   6. ‘checksum byte’

The first byte is the header byte and must have the specific value 0xAC (172¹⁰). If it does not have this value, the entire packet is discarded by the receiving command block.

The second byte is the command byte and defines the command that the base is asking the block to execute.

The third, fourth, and fifth bytes are the parameters for this command.

The sixth byte is the ‘checksum byte’.

B) The outgoing packets of blocks to the base have no memory limitation since the ESP memory is sufficient for large packet size.

So the packet is not a fixed size. The size is set by the command block before sending the packet.

The Packets Received by the Base from the Blocks have the Following Format:
1. The first byte is the header byte, and must always be 0xAC (172¹⁰). If the header byte does not have this specific value, the entire packet is discarded from the base.
2. The second byte is the size (N) of the data (without the ‘header byte’, and ‘checksum byte’).
3. Followed by ‘N’ bytes, exactly according to the number taken from the second byte.
4. The last byte is the ‘checksum byte’.

The checksum is used to check for data loss during transfer.

The checksum includes the entire packet, except the ‘header byte’ and the ‘checksum byte’ itself.

To calculate the checksum, the program initializes a byte with a value of 0xFF (25510). Then, for each byte of the packet, it subtracts the value of the byte. In case of overflow, the value is reset to 0xFF (25510).

In case the command block is a single command, when it is started, it adjusts its parameter port feed according to the ‘isSpecial’ flag.

In the case of an activated flag, the ‘VP_1’ pin is the positive power supply and the ‘VP_2’ pin is the ground. In the case of a deactivated flag, the opposite happens.

If the ‘enableVP’ flag is disabled (regardless of the value of the ‘isSpecial’ flag), then the power supply of the parameter is disabled, i.e. pins VP_1 and VP_2 are set to ground.

To avoid loading the ‘COMMON BUS’ with unwanted data, each instruction block has a three-state gate, which is controlled by the microcontroller of each block by the ‘GATE_CTNL’ pin. The three-state gate is enabled by logic ‘1’, and is always disabled, via a pull-down resistor, and is only enabled when the command block needs to send data to the bus. To avoid data conflict, after each data is sent to the ‘COMMON BUS’, each command block runs a time delay.

Each instruction block, in sequence, waits for data to be found on the serial stack. When data is found, it reads 6 bytes.

In case the data is less than six, then 100 ms after the last byte is received, timeout occurs, and the remaining bytes, to be filled, automatically become ‘0’.

After the command block reads the data, it checks if the header byte has the correct value. If it is not correct, then the packet is ignored, and the command block starts waiting for data in its serial again.

If the header byte is correct, then the command block checks the ‘checksum byte’. If it is not correct, then the packet is ignored, and the command block starts waiting for data in its serial again.

If the ‘checksum byte’ is correct, then the command block checks the ‘command byte’. In case the command is of type ‘basic’, directly the command block starts the process of decoding and executing the command.

If the ‘command byte’ is a ‘prompt’ type command then it checks the ‘parameter1 byte’ if it is non-zero. It then decrements this byte by one unit and then sends a new packet with the same command byte received, recalculating the new checksum, and decrementing it by one ‘parameter1 byte’, to the command block attached at the next position.

If the ‘parameter1 byte’ is zero, then the command block starts the process of executing the received command.

The Commands Received by the Blocks are Divided into the Following Categories:

### 1. Basic Commands

Commands that are executed directly from the command block.

The Commands of this Type are:
Reading settings
Writing of settings
Size reading
Writing size
Memory reading
Memory writing

### 2. Promotion Commands

These commands are executed if the ‘parameter1 byte’ parameter is 0. If the ‘parameter1 byte’ parameter is not 0 then they are forwarded to the next block.

The Commands of this Type are:
Identity Reading
LED control
LED animation

In the case of an Identity Read command, the block first activates the output of the three-state gate.

It then reads from the EEPROM the amount of data (‘length’) it needs to send. It writes to the serial the ‘header byte’, and the ‘length’ of the data to be sent.

In the case of single instruction blocks, the ‘length’ is increased by one, to allow the value from the parameter block, which may be attached to the instruction block, to be sent. If there is no parameter block attached then the value automatically becomes ‘1’.

It then sends the data it reads from the EEPROM and checks if it is a single instruction block. If it is, it reads and sends the value of the parameter block. At the end, it sends the calculated checksum and turns off the three-state gate.

In the case of an LED control command, the block reads from the parameter ‘parameter2 byte’ the last four bits, switches on or off LEDs 1,2,3,4 accordingly, and finally responds with an acknowledgment (ACKNOWLEDGE).

The ‘LED Animation’ command performs the predefined effect on the block.

The ‘Read Memory’ command is for reading a specific location value from the EEPROM.

The ‘Memory Write’ command is for writing a value to a specific location in the EEPROM.

The ‘Write size’ command is about writing a specific value to the ‘length’ location of the EEPROM.

The ‘Read size’ command is for reading a value from the ‘length’ location of the EEPROM,

The ‘Write settings’ command refers to writing a specific value to the ‘setting’ location in EEPROM.

The ‘Read settings’ command is for reading a value from the ‘setting’ location of the EEPROM.

### The Command Blocks Version 2^{η}

The instruction block consists of a microcontroller that is responsible for all the operations that the block performs. The instruction block circuitry may have multiplexing so that a pin inside the block can be used to achieve variable data direction to the correct output.

The block is connected from left to right. So each block on its left side can be connected either to a base or to another block. On its right side, however, whenever there is a connection, it is always connected to another block.

Each block has a parameter port at the bottom, to which only parameter blocks are connected.

The block is powered from the left port and downgraded to 3.3vDC.

The block circuit consists of the following parts:
The main microcontroller (indicatively ATmega328)·
The voltage stabilizer
The connecting ports.
The information LEDS
The data output port selection gates

The block firmware is written in the C++ programming language.

Each block needs 1 serial port to communicate with the base and the next-in-line command block.

In particular, the block reads from the ‘ATMEL_RX’ pin of the circuit, from the previous block. It writes data to the next block as well as to the base via the ‘ATMEL_TX’ pin.

The choice of which channel to write to is made by the three-state gates. Gate U3 selects ‘COMMON BUS’ as the output, and allows data to be written to the ‘GATE_FB_OUT’ pin. While gate U4 selects the next in-order instruction block as output, and allows data to be written to the ‘GATE_NEXT_OUT’ pin. The gate is controlled by the ‘GATE_FB_CTNL’ pin and the ‘GATE_NEXT_CNTL’ pin respectively.

The configuration of the command blocks is done by a byte stored in the EEPROM at position 0xFF.

Data packets do not have a fixed size. The size is set by the sender before sending the packet.

### The Packages Follow the Following Format

1. The first byte is the ‘header byte’, and must always be 0xAC (172¹⁰). If the ‘header byte’ does not have this specific value, the entire packet is discarded by the robot.
2. The second byte is the size of the data (without the ‘header byte’, and ‘checksum byte’).
3. They are followed by ‘N’ bytes, exactly according to the number they got from the second byte.
4. The last byte is the ‘checksum byte’.

In particular, command packets have at least one byte of data that is the identifier of the command to be executed. The remaining bytes, if any, are the parameters of the command (‘parameter1 byte’, ‘parameter2 byte’ etc.) numbered from one and incremented according to how many parameters the command needs.

Because blocks have limited memory, their stack size is 10 bytes, which means the maximum packet size is 7 bytes, plus the ‘header byte’, ‘length byte’, and ‘checksum byte’. In the case of a packet of a larger size, the packet is not stored in the stack but is decoded byte-byte.

The checksum is used to check for data loss during transfer.

The checksum calculation includes the whole packet, except the ‘header byte’ and the checksum byte itself.

To calculate the checksum, the program initializes a byte with a value of 0xFF (25510). Then, for each byte of the packet, it subtracts the value of the byte. In case of overflow, the value is reset to 0xFF (25510).

In case the instruction block is a single instruction, when it is started, it adjusts the power of its parameter port (pins VP_1, VP_2) according to the ‘isSpecial’ flag.

In the case of an activated flag, the VP_1 pin is the positive power supply and the VP_2 pin is the ground. In the case of a deactivated flag, the opposite happens.

If the ‘enableVP’ flag is disabled (regardless of the value of the ‘isSpecial’ flag), then the power supply of the parameter is disabled (pin VP_1, VP_2), i.e. both VP_1 and VP_2 are set to ground.

Because the instruction block writes data to two different outputs, the selection of the data output is done by the two three-state gates.

In case the command block wants to send data to the base then it activates (sets to logic 1) the ‘GATE_FB_CTNL’ pin. While in case it wants to write data to the next in-sequence command block, it activates the ‘GATE_NEXT_CTNL’ pin.

After the output is selected the command block writes data to the ‘ATMEL_TX’ pin. This data passes through the three-state gate and reaches its recipient.

### Command Reading Process

Each instruction block, in sequence, waits for data to be found in the serial stack. When data is found, it begins to read.

The block waits to read the first byte which must be 0xAC. After the first byte (0xAC) is read, then the next byte is the size of the packet to be received.

It reads as many bytes as the size of the packet, and then one more byte which is the checksum.

If no data is found after 100 ms after the last byte is received, a timeout occurs.

The command block controls the ‘checksum byte’. If it is not correct, then the packet is ignored, and the command block starts waiting for data in its serial again.

The commands received by the command block are of different sizes depending on the command received. Always the third byte of the packet is the ‘command byte’.

If the instruction is of a ‘basic’ type, the block directly starts the process of decoding and executing the instruction.

If the ‘command byte’ is a ‘forward’ type command then it checks the ‘parameter1 byte’ (fourth byte of the packet), if it is non-zero, it decrements the value of the ‘parameter1 byte’ by one. It then sends a new command block packet bound to the next location with the same ‘command byte’ received, again calculating the new checksum, and the decremented by one ‘parameter1 byte’.

If the ‘parameter1 byte’ is zero, then the block starts the process of decoding the received command.

The Commands Received by Blocks are Divided into the Following Categories:

### 1. Basic Commands

Commands that are executed directly from the command block.

The Commands of this Type are:
Reading settings
Writing of settings
Size reading
Writing size
Memory reading
Memory Writing

### 2. Promotion Commands

These commands are executed if the ‘parameter1 byte’ parameter is 0. If the ‘parameter1 byte’ parameter is not 0 then they are forwarded to the next block.

The Commands of this Type are:
Identity Reading
LED control
LED animation

In the case of an Identity Read command, the block first activates the output of the three-state gate.

It then reads from the EEPROM the amount of data (‘length’) it needs to send. It writes to the serial the ‘header byte’, and the ‘length’ of the data to be sent.

In the case of single instruction blocks, the ‘length’ is increased by one, to allow the value from the parameter block, which may be attached to the instruction block, to be sent. If there is no parameter block attached then the value automatically becomes ‘1’.

It then sends the data it reads from the EEPROM and checks if it is a single instruction block. If it is, it reads and sends the value of the parameter block. At the end, it sends the calculated checksum and turns off the three-state gate.

In the case of an LED control command, the block reads from the parameter ‘parameter2 byte’ the last four bits, and depending on this turns on or off the LEDs 1,2,3,4, and finally answers ACKNOWLEDGE.

The ‘LED Animation’ command performs the predefined effect on the block.

The ‘Read Memory’ command is for reading a specific location value from the EEPROM.

The ‘Memory Write’ command is for writing a value to a specific location in the EEPROM.

The ‘Write size’ command is about writing a specific value to the ‘length’ location of the EEPROM.

The ‘Read Size’ command is for reading a value from the ‘length’ location of the EEPROM,

The ‘Write settings’ command refers to writing a specific value to the ‘setting’ location in EPPROM.

The ‘Read settings’ command is for reading a value from the ‘setting’ location of the EEPROM.

### The Parameter Blocks

The configuration of the parameter block is done by the command block to which it is attached.

If the ‘enableVP’ flag of the command block is disabled, then the command block does not accept a parameter and sets the ‘VP1’ and ‘VP2’ pins to 0vDC. Otherwise, it sets them as follows:

a) In the case of an ‘IF’ type command, the command block sets the ‘VP2’ pin to 3.3vDC and the ‘VP1’ pin to 0vDC.

b) In any other case, the command block sets the ‘VP1’ pin to 3.3vDC, and the ‘VP2’ pin to 0vDC.

The parameter block is read via the ‘Sense1’ and ‘Sense2’ pins. ‘Sense1’ and ‘Sense2’ are internally connected to the analog-to-digital converter of the command block.

When the read process starts, the command block reads the analog pins ‘Sense1’ and ‘Sense2’. Depending on the type of command, it expects to read a predefined voltage value on the ‘Sense1’ or ‘Sense2’ pin. This value is determined by the voltage divider generated, the parameter resistance, and the internal resistance of the command block.

If the command block is of type ‘IF’ then the command block expects the constant value to be on the ‘Sense2’ pin. In any other case, the constant value is on the ‘Sense1’ pin

If there is no parameter block connected, then no voltage divider is created, and the command block recognizes it and returns the appropriate value to the base.

If the voltage divider is found on the expected pin, then the value of the command parameter is determined by the value of the other ‘Sense’ pin, on which a voltage divider proportional to the value of the ‘RVariable’ resistor is generated.

With this mechanism (fixed voltage on the ‘Sense1’ or ‘Sense2’ pins and value measurement on the ‘Sense2’ or ‘Sense1’ pins respectively) is allowed: a) parameters can be connected on both sides (top or bottom), i.e. inverted, representing different meanings on each side, i.e. one side has a number as a parameter and the other side has sensor as a parameter, b) there can be different kinds of parameters that have switches, LDR potentiometers on them, which somehow change the ‘RVariable’.

Thus, each parameter block may incorporate both a number parameter and a sensor parameter. The concept that parameterizes the command block is the number or the sensor, depending on how the parameter is connected to the command block. Typically, each side (up or bottom) depicts the concept (number or sensor) and the command block is parameterized depending on which side of the parameter is up and depicts the concept.

### Specifically the ‘RVariable’ can be One of the Following:

Fixed resistance with a discrete, predetermined value
Potentiometer with a range of discrete values
Switch (ON-OFF) in ON and OFF mode.

In particular, the switch has a discrete resistance. If the switch is off (open circuit) then the command block reads the value of the resistance. In case the switch is on (closed circuit) then the command block reads a voltage of 3.3vDC.

### Robot-Base Connection

The connection between the base and the robot is made through the access point managed by the robot. This allows a direct and fast connection between the two devices, without the need for a third device to act as an intermediary between the two.

To have a successful connection between the robot and the base, the robot name must be the same as the base name. Otherwise, the user will have to log in to the access point of the base, so that the robot's data (name and password) can be entered.

Communication is done via HTTP, between the base and the robot.

In the first stage of the connection, the base asks for the robot's data, the version of the base software that the robot requires the base to have, and the user's settings. The base compares its software version with the version requested by the robot. If the version is the same then the connection is established, and the communication has been successfully established. After the base has connected to the robot, the base disables its Access Point.

In case the versions are not the same, the base requests and downloads the version requested by the robot from the robot's server. Then the software upgrade procedure of the base is followed. Given the above way of communication, it is possible to connect multiple bases to one robot.

### Base Connection—Command Block Connection

The Base—Command Block connection is made via male and female magnetic connectors.

The four pins of the connector, in order from top to bottom, are as follows:

The first pin is the positive connection of the power supply, which internally in the base is connected to the positive pole of the battery, via the base's power off switch.

The second pin of the connector is for data exchange. With this pin, the base sends, serially, data to the command block, which is connected to the port.

The third pin of the connector is for returning data. With this pin, the command blocks send, serially, data to the base. This pin is common to all command blocks, forming a ‘COMMON BUS’. To avoid interference in data exchange, each instruction block has a three-state gate, which isolates (sets ‘GATE_OUT’ to high resistance) the ‘COMMON

BUS’ from all instruction blocks except the instruction block that writes data to the ‘COMMON BUS’.

The fourth pin is the power supply ground.

To avoid errors during the connection-disconnection of instruction blocks, each instruction block has a ‘pull-down’ resistor at the beginning of the data receive line. The resistor has a value of 10k.

Also to avoid errors in the ‘COMMON BUS’, there is a ‘pull-down’ resistor in the base, right at the beginning of the data receiving line.

### DESCRIPTION OF THE DRAWINGS

FIG. 1 shows the base (1), with the “Run” button (2) and the “Save” button (3). The base (1) has recesses (4), projections (5), magnets (6), a pin to which the power supply ground (7) is connected, a pin to which the common communication bus (8) is connected, a pin to which the data transfer (9) is made, and a pin to which the power supply is connected (10). The base has two sets of pins (a) on the ‘Execute’ port (11) and (b) on the ‘save’ port (12).

FIG. 2 shows a command block (13), with recesses (4), projections (5), magnets (6), a pin to which the power supply ground (7) is connected, a pin to which the common communication bus (8) is connected, a pin to which the data transfer (9) is made and a pin to which the power supply is connected with energy (10), a previous command block or base connection port (14). Also, the command block (13) has a next command block connection port (16), a parameter read port (15) which has a pin to which the parameter power supply (VP2) is connected (17), a pin to which the parameter information is read (Sense2) (18), a pin to which the parameter information is read (Sense1) (19) and a pin to which the parameter power supply (VP1) is connected (20).

FIG. 3 shows a parameter block (21), the parameter to command block connection port (22), which has a pin to which the parameter power supply (VP2) (17) is connected, a pin to which the parameter information is read from the parameter (Sense2) (18), a pin to which the parameter information is read from the parameter (Sense1) (19), and a pin to which the parameter power supply (VP1) (20) is connected.

FIG. 4 shows the robot (23) at an angle, which has a display (24), a magnetic frame around the display (25), an aluminum apron (26), wheels (27), a multi-function sensor, i.e. gesture, color, light and distance sensor (28), a capacitive touch sensor (29), a temperature sensor (30) and lights (31).

FIG. 5 shows the robot (23) in profile and the outputs of the speakers (32) it has.

FIG. 6 shows the rear view of the robot (23), which shows holes (32) that allow the speaker to transmit the sound it produces and holes (33) behind which the sound sensor is located.

FIG. 7 shows the whole system, showing the base (1), with the “Run” button (2) and the “Save” button (3), the instruction blocks (13), the parameter blocks (21) connected to the instruction blocks, the robot (23), and a device for connecting the robot for GUI guidance (35). Also, command blocks are shown connected to the ‘save’ port of the base with a power supply grounding pin (7), a pin to which the common communication bus (8) is connected, a pin to which data transfer (34) is made to the next in line command block, a pin to which the power supply is connected with power (10), and a next command block connection port (16).

FIG. 8 shows how the circuits are connected, where a microcontroller (100) is located inside the base, connected internally, on one side, to the “Run” button (101) and the “Save” button (102) and, on the other side, to the “Run” port (103) and the “Save” port (104). At each output, there are four pins, of which the first is used for power supply (105), the second for sending information (106), the third as a common communication bus (108), and the fourth as a ground (107). Through the Execute port, the instruction blocks (109) return instructions to the base, and some instruction blocks are connected with parameter blocks (110). Through the Store port (104), the base may store code in the connected commands block (109).

FIG. 9 shows the graphical representation of the robot's circuitry, which consists of the microcontroller (111), the outputs, the inputs, the external memory (122), and the circuitry for the WiFi connection (123). The inputs consist of the temperature sensor (113), touch sensor (114), microphone (115) that acts as a sound sensor, and APDS (112) that acts as a distance sensor (123), gesture sensor (125), and light sensor (126). The outputs consist of the motor driver (116), the motors (117), the LED lights (118), the speaker driver (119), the speaker (220), and the display (221).

FIG. 10 illustrates the system connections. The robot (127) is connected to a base (128). Through the local router (130), the robot connects to the Internet (131) to access the remote network server (133) as well as Internet services (134). The local user (129) connects either directly to the robot (127) or through the local router (130). The remote user (132), in order to communicate with the robot (127), connects via the internet (131) to the remote network server (133) to which the robot (127) is connected.

FIG. 11 shows the system's algorithm for executing the commands. After the system is powered on, i.e. after the blocks are joined to the base, the execute button (134) is pressed, the pointer (parameter_1 byte) is initialized with a value of ‘0’ (135), a read command is sent to the ‘execute’ port (block) with the value of the pointer (136), if a command block is connected (137), then the command block activates the connection to the common communication bus (138), and sends the command and parameter identifier (139), the base stores the received command and parameter and increments the pointer by one unit (140). This (136 to 140) is repeated until all blocks are read. When there is no other command block connected to be read (137) because all were read, the system proceeds to initialize a new pointer with a value of ‘0’ (141), the base decodes the stored command with a pointer value (142), a command to turn on the LED light of the command block is sent (143), the command is sent and executed by the robot (144), at the time the robot is executing a command, the LED in the corresponding command block whose command is being executed is lit, and, after the execution of the command, a command to turn off the LED of the command block (145) is sent. The system then searches for another stored instruction to be executed (146). If there is another instruction, the index is incremented by one unit and the same procedure (142-147) is repeated until the instructions to be executed stored in the base are exhausted. When the instructions to be executed are exhausted, the end of execution occurs (148).

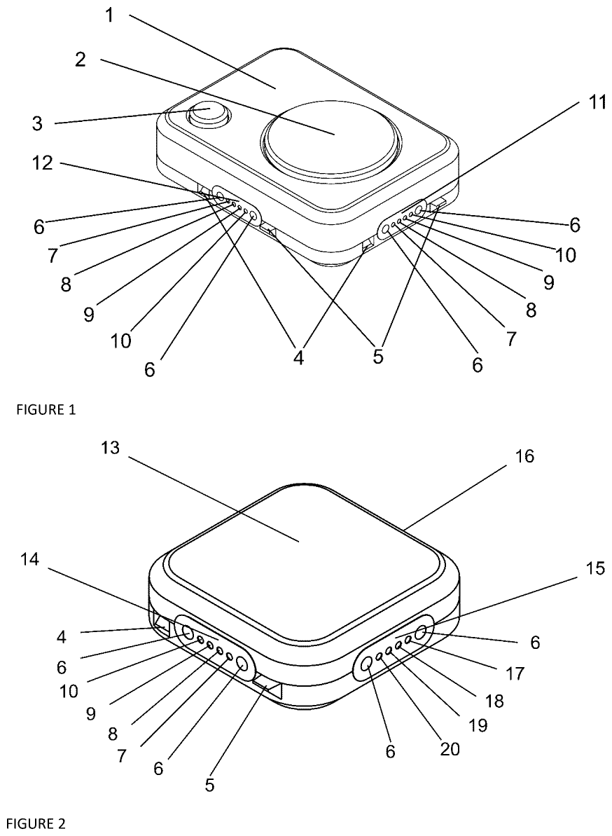

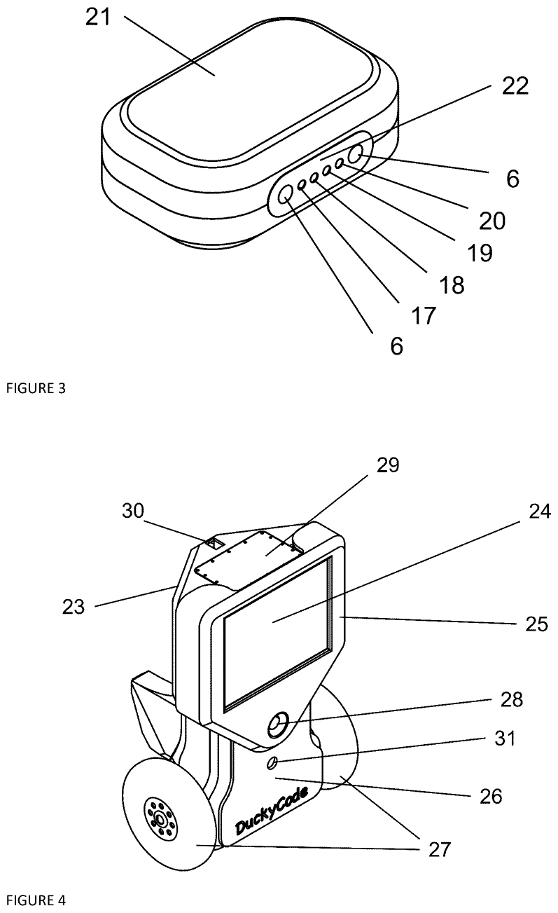

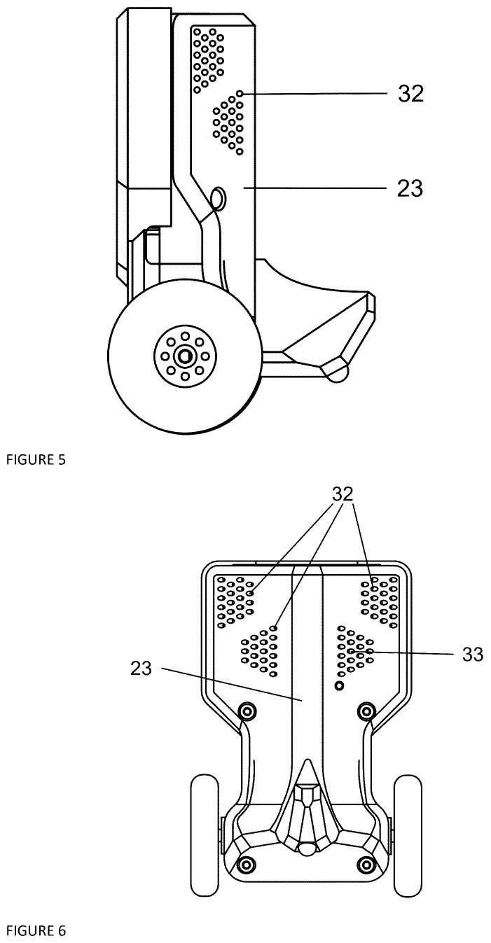

### REALIZATION OF THE INVENTION

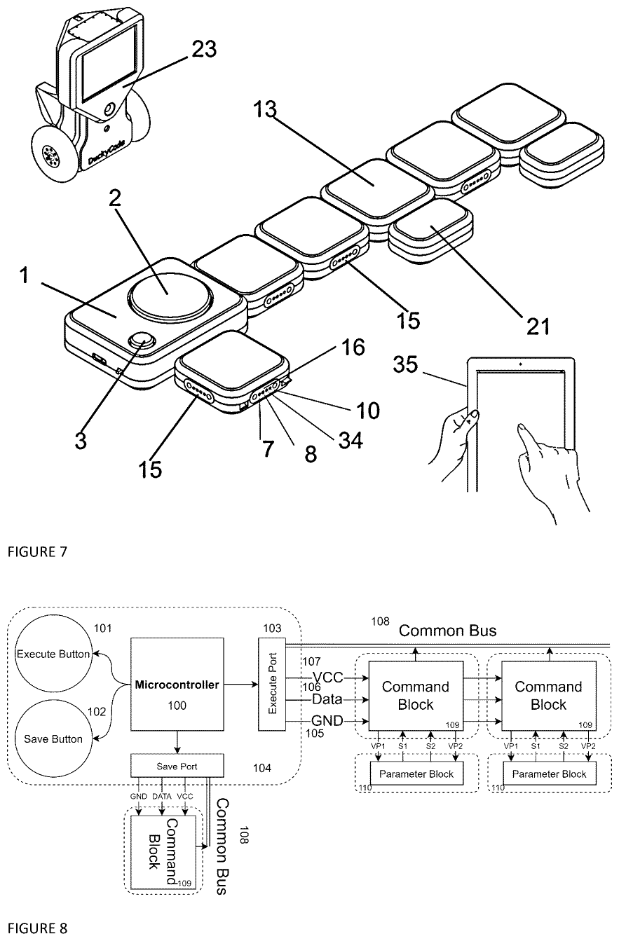

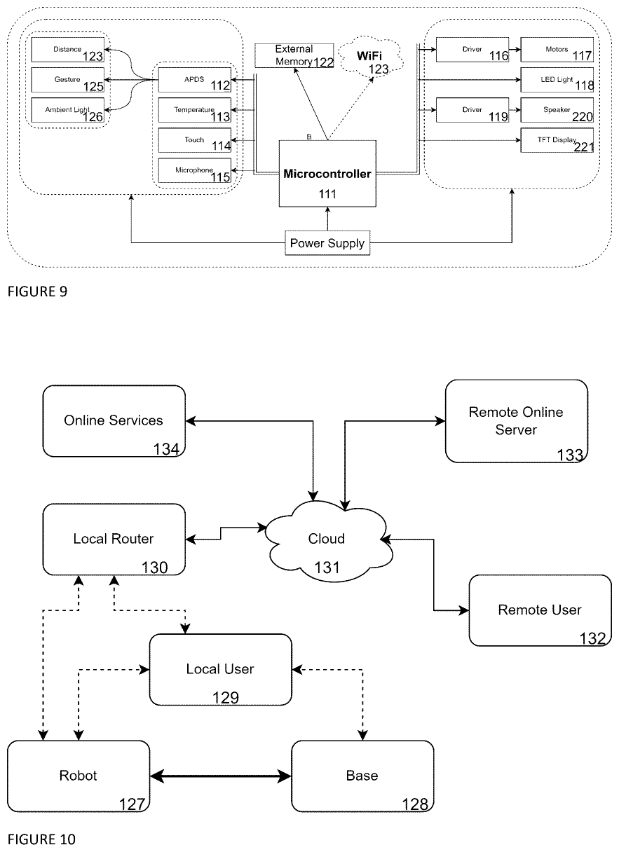

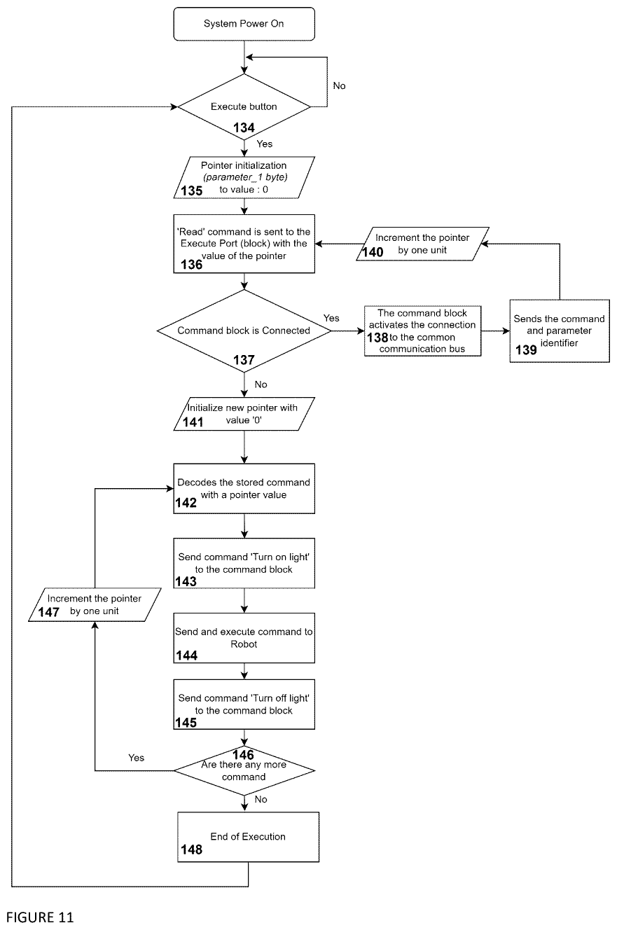

Example 1 (FIG. 7) shows the system used to send commands to guide the robot by tangible means as follows: (a) blocks with stored commands (13) are connected to the base (1), with connection achieved by the magnets and the recesses—projections mechanism; (b) the wiring of the power supply, the command transmission, the grounding and the common communication bus are aligned, through which the stored commands are returned from the blocks to the base, c) parameters are connected to the command blocks (21), d) the execute button (2) is pressed, e) the base (1) sends a read request to the command blocks (13) in sequence, f) the request is transmitted from the block closest to the base (1) to the furthest block, through the aligned wiring, g) each command block (13), taking into account any parameter block (21) connected, sends the command stored, which may or may not be parameterized, to the common communication bus (108), through which all commands from the blocks are transmitted to the base (1) and the base (1) sends one by one the commands to the robot (23) for execution, h) the robot (23) executes the commands, i) each time the robot (23) executes a command a light is switched on in the corresponding command block (13) whose command is being executed.

1. An educational robot guidance system consisting of a) a robot (23), b) a base (1), c) blocks of stored commands (13), d) a communication bus (9), and e) parameter blocks (21), with a modular communication bus system, for a programmable tangible block assembly, with which a plurality of command blocks are physically connected in series and communicate with the base unit wherein each parameter block:
i) has two functional orientations, such that when connected in an upright or inverted configuration, it represents a distinct parameter (e.g., a numeric value vs. a sensor);
ii) connects to a command block with four pins:
a. A pin to which the parameter power supply is connected,
b. a pin to which the parameter information Sense1 is provided,
c. a pin to which the parameter information Sense2 is provided, and
d. a pin to which the parameter power supply is connected;
iii) Is connected to the analog-to-digital converter of the command block.

2. An educational robot guidance system as described in claim 1, wherein a plurality of command blocks are physically connected in series and communicate with a base unit, the system comprising:
i) the common communication bus is shared by all blocks and the base unit;
ii) a direct electrical connection from each command block to the common communication bus;
iii) a microcontroller within each command block;
iv) a three-state gate.

3. The educational robot guidance system of claim 1, wherein the power supply, grounding line, data transmission line, and communication bus are aligned within a standardized wiring interface.

4. The educational robot guidance system of claim 1, wherein each command block has a unique command identifier and an associated parameter identifier.

5. Software implemented method for reading the parameter blocks by the command blocks, as follows:
i) the Sense1 and Sense2 pins in the parameter blocks are internally connected to the analog-to-digital converter of the command block;
ii) when the read process starts, the command block reads the analog pins Sense1 and Sense2;
iii) Depending on the type of command, it expects to read a predefined voltage value on the Sense1 or Sense2 pin;
iv) this value is determined by the voltage divider generated, the parameter resistance, and the internal resistance of the command block;
v) if the voltage divider is found on the expected pin, then the value of the command parameter is determined by the value of the other ‘Sense’ pin, on which a voltage divider proportional to the value of the ‘RVariable’ resistor is generated.

6. Software implemented method for reading the parameter blocks by the command blocks as described in claim 5, wherein the configuration of the parameter block is done by the command block to which it is attached, as follows:
i) If the ‘enableVP’ flag of the command block is disabled, then the command block does not accept a parameter and sets the ‘VP1’ and ‘VP2’ pins to 0Vdc;
ii) Otherwise, it sets them, as follows:
a) In the case of an ‘IF’ type command, the command block sets the ‘VP2’ pin to 3.3vDC and the ‘VP1’ pin to 0vDC;
b) In any other case, the command block sets the ‘VP1’ pin to 3.3vDC, and the ‘VP2’ pin to 0vDC.

7. Software implemented method for operating the educational robot, wherein the commands are saved from the GUI as follows:
i) The GUI, through Blockly, collects the commands of the program created by the user and asks the user to select the base to which the multi-command block is connected;
ii) After selecting the correct base, from the list of connected bases, press the “DONE” button on the GUI;
iii) The robot sends the program to the base for storage, and the base in turn starts the program storage process;
iv) First, the base stores the commands it has received in a table;
v) The base checks the number of bytes it will try to store in the multi-instruction block, if it exceeds 250, then it rejects the storage;
vi) It then checks, sending the “alive” command to the command block located in the ‘save’ port. If there is a command block then it responds with an acknowledgment (ACKNOWLEDGE), and the base knows that there is a command block;
vii) The base reads the Settings Byte of the block in the ‘save’ port, and checks if the block is a multi-instruction block, and is available for writing. If it is not, storage is rejected;
viii) Then one by one the base sends the bytes of the commands with the “WRITE EEPROM” command, with the memory location as a pointer. The base waits up to 1 second for a response from the multi-instruction block. If it does not receive it, a timeout occurs. The attempt is repeated up to three times. This is done in case the user removes the command block, or the EEPROM has reached the maximum write cycle;
ix) After, and if, all bytes are written, then the base sends the “WRITE_LENGTH” command, with the number of commands as the value. Thus the multi-instruction block has recorded both the instructions and their number;
x) The process at this point is complete and the base responds to the robot;
xi) In turn, the robot displays a message in the GUI, depending on whether the storage was successful or not.

8. Software implemented method as described in claim 7, wherein the commands of variable command blocks change as follows:
i) The application sends an HTTP request to the robot's server, the endpoint responsible for the process. Giving the ‘LocalIP’ of the selected base, and the selected command as ‘query’ parameters. The robot waits for a response to the request;
ii) The robot sends a request to ‘LocalIP’ on the Endpoint responsible for the process, giving the selected command as a query parameter;
iii) The base receiving the request sends the “read command” command to the ‘save’ port to check if there is a connected block;
iv) If there is no block it returns an error;
v) The base sends a read command of the ‘Setting Byte’, and checks if the block is a variable command block;
vi) If it is not, it returns an error;
vii) It then sends an EEPROM storage command, with address ‘0’ and value the command;
viii) If it is not successful the action returns incorrectly;
ix) If it is successful, it returns with a success message;
x) The robot gets the answer and returns the same message to the request;
xi) The Dashboard gets the response and displays the message on the user's screen.

9. Software implemented method as described in claim 7, wherein the firmware update process is automatically initiated as follows:
i) when the base is connected to a robot if the software version of the base does not match the version required by the robot;
ii) the base downloads the software file from the robot and stores it in the ‘Update’ memory area and starts the software located in the ‘Factory App’ memory area, copies from the ‘Update’ memory area to the ‘Main App’ memory area, erases the contents of the ‘Update’ memory area and starts the software located in the ‘Main App’ memory area;
iii) In case of incorrect firmware, the base starts the application located in the ‘Factory App’ memory area and copies the application located in the ‘Backup’ memory area to the ‘Main App’ memory area and starts the software located in the ‘Main App’ memory area;
iv) The ‘Backup’ memory area contains the latest stable version of the base software from the manufacturer.
